(19) United States
(12) Patent Application Publication
(10) Pub. No.: US 2008/0246214 A1
(43) Pub. Date: Oct. 9, 2008

(54) Dice Game Machine And Dice Game Method

(75) Inventor: Hirobumi TOYODA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Corp., Koto-ku (JP)

(21) Appl. No.: 12/059,244

(22) Filed: Mar. 31, 2008

(30) Foreign Application Priority Data
Apr. 3, 2007 (JP) JP2007-097297

(51) Int. Cl. A63F 9/04; A63F 13/00

(52) U.S. Cl. 273/146; 273/274; 463/16; 463/25

(57) ABSTRACT

A dice game machine of the present invention has: a table on which a plurality of ice roll, the table having pockets in which at least one of the plurality of dice drops; a vibration section for vibrating the table to roll the dice on the table; a player terminal, which enables a player to perform BET operation while predicting at least either of rolled numbers of the dice existing on the table after vibration of the table stops and rolled numbers of the dice that have dropped in the pockets; a rolled-number recognition section for recognizing rolled numbers of the plurality of dice that has stopped after vibration of the table stops; a controller for controlling vibration of the table and a timing at which the vibration of the table stops; accepting BET operation from the BET operating section; and controlling payout processing of a gaming value corresponding to a payment, with referring to rolled numbers of dice specified by the rolled-number recognition section.

### CROSS-REFERENCE TO RELATED APPLICATIONS

This application is based upon and claims a priority from the prior Japanese patent Application No. 2007-097297 filed on Apr. 3, 2007, the entire contents of which are incorporated herein by reference.

### BACKGROUND OF THE INVENTION

1. Field of the Invention

The present invention relates to a dice game machine in which rolled numbers on a plurality of dice when rolled are predicted and a dice game method to be performed by such dice game machine.

2. Description of the Related Art

Generally, various game machines are installed in a game hall or a casino. Some of them include a dice game machine in which players perform a BET operation while predicting rolled numbers on a plurality of dice when rolling these dice. For dice games, various rules and machines, which are capable of performing these games, have been proposed. For example, US Patent Publication No. 2006/49578 proposes a dice game in which Craps are combined with SICBO that is a traditionally well-known dice game.

In general, SICBO is a dice game in which players make BET operation while predicting the rolled numbers of dice rolled after three dice have been rolled or a combination of numbers. Craps is a dice game, in which players make BET operation while predicting the rolled numbers of two dice after rolled or a combination of numbers. In either of the games, the dice are rolled by a dealer, and the players participate in the game by betting gaming values on a predetermined BET table while predicting the rolled numbers of the dice.

SICBO and Craps that are the dice games are classical in game per se and are simple in rules per se. Thus, even if the respective games are combined with each other, “new amusing attractiveness” and “surprising factors” are less given to the players. On the other hand, a completely new dice game lacks enjoyment, since the players are unfamiliar with such game, and a possibility arises where a plenty of players do not participate in such game.

The present invention has been made to overcome the above-described problem. It is an object of the present invention to provide a dice game machine and a dice game method, which are capable of enhancing enjoyment more.

### SUMMARY OF THE INVENTION

According to a first aspect of the present invention, there is provided a dice game machine, comprising: (a) a table on which a plurality of dice roll, the table having pockets in which at least one of the plurality of dice drops; (b) a vibration section for vibrating the table to roll the dice on the table; (c) a BET operating section, which enables a player to perform BET operation while predicting at least either of rolled numbers of the dice existing on the table after vibration of the table stops and rolled numbers of the dice that have dropped in the pockets; (d) a rolled-number recognition section for recognizing rolled numbers of the plurality of dice that are in a stopped state after vibration of the table stops; and (e) a controller for controlling vibration of the table and a timing at which the vibration of the table stops; accepting BET operation from the BET operating section; and controlling payout processing of a gaming value corresponding to a payment, with referring to rolled numbers of dice specified by the rolled-number recognition section.

According to the first aspect of the present invention, when a game is started, a table on which a plurality of dice are placed vibrates, and the plurality of dice roll on the table. At the time of this rolling, after some of these dice have dropped in pockets formed on the table, if the pockets are filled with the dice, vibration of the table stops. Then, at least either of rolled numbers of the dice that have been positioned on the table and those of the dice that have dropped in the pockets, are detected. A player can make BET operation while predicting at least either of the rolled numbers of the dice stopped on the table and those of the dice that have dropped in the pockets. After the game is started, the plurality of the dice will roll on the table and drop in or go out of the pockets. Thus, the player is caused to pay attention to the behavior of the dice, making it possible to enhance anticipation and excitement.

According to a second aspect of the present invention, there is provided a dice game machine, which is constituted as set forth below. In the first aspect, the dice game machine includes: a plurality of player terminals provided with at least the BET operating section; and an image display device that can be visually recognized from a player of each of the player terminals, wherein the controller causes the image display device to display an effect image when the dice on the table vibrates.

According to the second aspect of the present invention, the image display device provides an attractive effect together with rolling of a plurality of dice, thus making it possible to augment an atmosphere until a result of a dice game is obtained and to enhance enjoyment.

According to a third aspect of the present invention, there is provided a dice game machine, which is constituted as set forth below. In the first aspect, the rolled-number recognition section recognizes rolled numbers of the dice existing on the table after vibration has stopped and those of the dice that have dropped in pockets.

According to the third aspect of the present invention, the player can predict a plurality of the rolled numbers of the dice positioned on the table and those of the dice that have dropped in the pockets, making it possible for the player to predict more rolled numbers and to enhance enjoyment.

According to a fourth aspect of the present invention, there is provided a dice game machine, which is constituted as set forth below. In the first aspect, the controller executes, for the player, game processing capable of acquiring an additional gaming value, in a case where either of the rolled numbers of the dice on the table and those of the dice that have dropped in pockets are obtained in a predetermined combination and the player has made BET operation for the predetermined combination.

According to the fourth aspect, in a case where the rolled numbers of the dice that have stopped are obtained in a predetermined combination and the player has make BET operation while predicting such rolled numbers, for example, an additional game such as a bonus game is implemented. That is, a possibility arises where such additional game can be acquired, thus making it possible for the player to enhance enjoyment more.

According to a fifth aspect of the present invention, there is provided a dice game machine, which is constituted as set forth below. In the first aspect, the controller executes accumulation processing at a predetermined rate among a BET amount determined when the player makes BET operation; and executes, for the player, payout processing of a past accumulation amount, in a case where either of rolled numbers of the dice existing on the table and those of the dice that have dropped in pockets are obtained in a predetermined combination and the player has made BET operation for the predetermined combination.

According to the fifth aspect, the player's BET amounts are accumulated on a game-by-game basis at a predetermined rate. Thus, the rolled numbers of the dice that have been positioned on the table or those of the dice that have dropped in pockets are obtained in a predetermined combination and a large payout amount occurs in a case where the player has made BET operation for the predetermined combination, so that the player performs a game with more interest. In addition, the rolled numbers of the dice for which such payout is made are set at a low probability, thereby making it possible to increase the payout amount more significantly and to enhance the player's excitement and anticipation.

According to a sixth aspect of the present invention, there is provided a dice game method, comprising the steps of: (a) vibrating a table on which a plurality of dice roll, the table having pockets in which at least one of the plurality of dice drops; (b) accepting processing for a player to make BET operation while predicting at least either of rolled numbers of the dice existing on the table after vibration of the table stops and rolled numbers of the dice that have dropped in the pockets; (c) recognizing rolled numbers of a plurality of specific dice after stopping vibration of the table; (d) judging whether or not rolled numbers of the plurality of specified dice conform to a predetermined condition; and (e) paying out a gaming value corresponding to a payment to the player in a case where it is determined that rolled numbers of the plurality of specified dice conform to a predetermined condition and the accepted BET operation is performed for the predetermined condition.

According to the sixth aspect of the present invention, when a game is started, a table on which a plurality of dice are placed vibrates, and the plurality of dice roll on the table. At the time of this rolling, after some of these dice have dropped in pockets formed on the table, if the pockets are filled with the dice, vibration of the table stops, and then, at least either of rolled numbers of the dice on the table and those of the dice in the pockets are detected. A player can make BET operation while predicting at least either of the rolled numbers of the dice stopped on the table and those of the dice that have dropped in the pockets. After the game is started, the plurality of the dice will roll on the table and drop in or go out of the pockets. Thus, the player is caused to pay attention to the behavior of the dice, making it possible to enhance anticipation and excitement.

According to a seventh aspect of the present invention, there is provided a dice game method, which is constituted as set forth below. In the sixth aspect, the dice game method further includes the step of executing special game processing capable of acquiring an additional gaming value to the player in a case where either of rolled numbers of the dice on the table and rolled numbers of the dice that have dropped in pockets are obtained in a predetermined combination and the player has made BET operation for the predetermined combination.

According to the seventh aspect, in a case where the rolled numbers of the dice on the table or those of the dice that have dropped in the pockets are obtained in a predetermined combination and the player has made BET operation while predicting such rolled numbers, for example, an additional game such as a bonus game is implemented. That is, a possibility arises where such additional game can be acquired, thus making it possible for the player to enhance enjoyment more.

According to an eight aspect of the present invention, there is provided a dice game method, which is constituted as set forth below. In the sixth aspect, the dice game method further includes the step of: executing accumulation processing at a predetermined rate among a BET amount when the player makes BET operation; and executing, for the player, payout processing of a past accumulation amount, in a case where either of rolled numbers of the dice on the table and rolled numbers of the dice that have dropped in pockets are obtained in a predetermined combination and the player has made BET operation for the predetermined combination.

According to the eighth aspect, the player's BET amounts are accumulated on a game-by-game basis at a predetermined rate. Thus, the rolled numbers of the dice on the table or those of the dice that have dropped in pockets are obtained in a predetermined combination and a large payout amount occurs in a case where the player has made BET operation for the predetermined combination, so that the player performs a game with more interest. In addition, the rolled numbers of the dice for which such payout is made are set at a low probability, thereby making it possible to increase the payout amount more significantly and to enhance the player's excitement and anticipation.

According to the present invention, a dice game machine and a dice game method, which are capable of enhancing enjoyment more, can be provided.

### BRIEF DESCRIPTION OF THE DRAWINGS

FIG. 1 is a perspective view showing an exemplary entire configuration of a dice game machine according to the present invention;

FIG. 2 is a view showing a schematic structure of a gaming section;

FIG. 3 is a block diagram depicting an exemplary rolled-number detection device;

FIG. 4 is a view showing an exemplary picked up image of dice obtained by the rolled-number detection device shown in FIG. 3;

FIG. 5 is a view showing a display example of a BET screen that enables BET operation for dice stopped on a table;

FIG. 6 is a view showing a display example of a BET screen that enables BET operation for dice that have dropped in pockets;

FIG. 7 is a block diagram schematically depicting a control system of a dice game machine;

FIG. 8 is a block diagram schematically depicting a control system of a player terminal;

FIG. 9 is a flowchart showing a control operation of procedures for executing a dice game between a main controller of the dice game machine and a player terminal;

FIG. 10 is a view showing a state of a plurality of dice that have been positioned on a table;

FIG. 11 is a view showing a state of a plurality of dice rolling on the table; and

FIG. 12 is a view showing a stopped state of a plurality of dice that have been positioned on the table and a state of dice that have dropped in pockets.

### DESCRIPTION OF THE PREFERRED EMBODIMENTS

A dice game machine according to the present invention is provided with a table on which a plurality of dice roll, the table comprising pockets in which some of the plurality of dice drop. This table is designed to be vibrated by means of a vibration mechanism, whereby the plurality of dice existing on the table are rolled and some of the plurality of dice are dropped in pockets during vibration.

Players participating in a dice game make BET operation with the use of gaming media such as medals or coins while predicting rolled numbers of one or more dice finally remaining on the table and rolled numbers of one or more dice that drop in pockets.

A dice game is conducted by means of a control unit provided with a CPU. In a case where the rolled numbers of BET-operated dice have been won, this control unit performs payout processing gaming values to the player in accordance with the BET-operated contents.

Specifically, in the present embodiment, four pockets are provided on the table so that seven dice are used. The table vibrates, whereby three dice remain on the table, and four dice drop in the pockets. Players can make BET operation for either or both of the rolled numbers of the three dice remaining on the table and those of the four dice that drop in the pockets. BET operation is performed at a plurality of player terminals (8 stations) installed around a gaming section at which the dice roll.

Hereinafter, the dice game machine and a dice game method, according to the present invention, will be described with referring to the accompanying drawings.

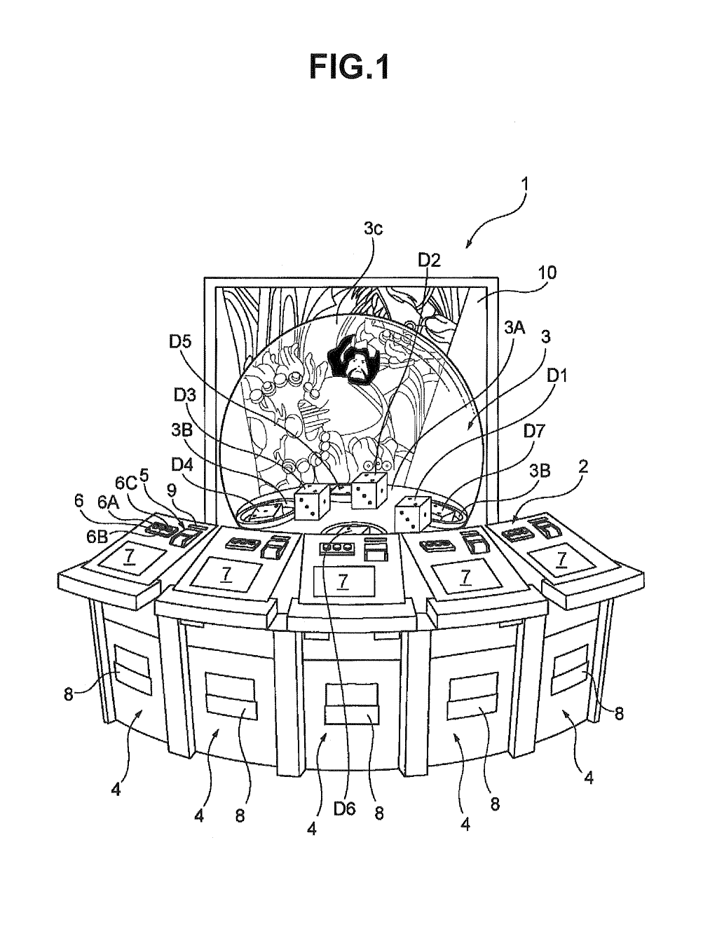

FIG. 1 is a view showing one embodiment of the dice game machine.

A dice game machine 1 is provided with: a cabinet 2 serving as a main body portion; a dice game execution section 3 (hereinafter, referred to as a gaming section 3) provided on an upper face of the cabinet 2; and a plurality of player terminals 4 (five terminals in the present embodiment) installed around the gaming section 3.

The player terminals 4 may be constituted such that players can make BET operation. Each of these player terminals is provided with: a gaming medium acceptance unit 5 for accepting the player's entry of gaming media such as bills and medals used in a game; a controller 6 made up of a plurality of control buttons or the like for players to enter predetermined instructions; and an image display device 7 for mainly displaying images pertinent to a BET table. Then, players operate the controller 6 or the like while observing the images displayed on the image display device 7, whereby they can participate in games to be successively implemented at the gaming section 3.

Payout openings 8 for paying out gaming media owned by players are provided, respectively, on side faces of cabinets 2 at which player terminals 4 were installed. Further, a speaker 9 for supplying music or effect sounds is provided at the top right of the image display device 7 of each of the player terminals 4.

The above-mentioned controller 6 is provided upwardly of the image display device 7 of the player terminal 4, and buttons to be operated by players are disposed. Specifically, a BET determination button 6A, a CASHOUT button 6B, and a HELP button 6C are disposed in sequential order from the left.

The BET determination button 6A is a button to be depressed at the time of determining BET after BET operation has been made by the image display device 7. Then, in a case where BET is determined and BET is performed for an area corresponding to the rolled numbers of dice at the gaming section 3 while in the play of a game, it is judged to be winning. In the case of winning, the credits corresponding to the number of betted chips are added to those currently owned by players, based upon a payment table.

The CASHOUT button 6B is, in general, a button to be depressed at the end of a game. When this button is depressed, the gaming media corresponding to the credits currently owned by players, the credits being acquired by a game or the like, are cashed out from the payout openings 8.

The HELP button 6C is a button to be depressed in the case where a game operation method or the like is unidentified. When this button is depressed, a HELP screen indicative of a variety of operational information is displayed on the image display device 7 immediately after the button is depressed.

The image display device 7, as described later, is a so called liquid crystal display of touch panel type on which a touch panel is mounted to a front face. An icon displayed on the liquid crystal screen is depressed by a finger or the like, thereby enabling a selection of the desired icon.

A circular table 3A on which seven dice D1 to D7 roll is installed at the gaming section 3 mentioned above. On the table 3A, four pockets (circular holes) 3B in which the dice can drop are formed. This table 3A is entirely vibrated by means of a vibrator described later so as to roll the dice D1 to D7. Thus, on the table 3A, a dome-shaped transparent cover 3C is installed so that the dice D1 to D7 do not fly out.

The dice game machine 1 is provided with a large image display device 10 so that all players can visually recognize the display of an image. This image display device 10 is made up of a projector and a liquid crystal display device or the like, and is installed so that all of the players sitting at the player terminals 4 can visually recognize the display of an image. This image display device 10 is caused to make an operation according to the progress of a dice game conducted at the gaming section 3 while the characters as shown in the figure, for example, are caused to appear. For example, an image is displayed such that rolling dice are handled by a palm, or alternatively, a special action or an attractive effect is taken when a bonus game or a jack pocket described later is established, whereby a player can enjoy such video image in addition to the dice game to be performed at the gaming section 3.

Next, a method of activating the table 3A mentioned above will be described.

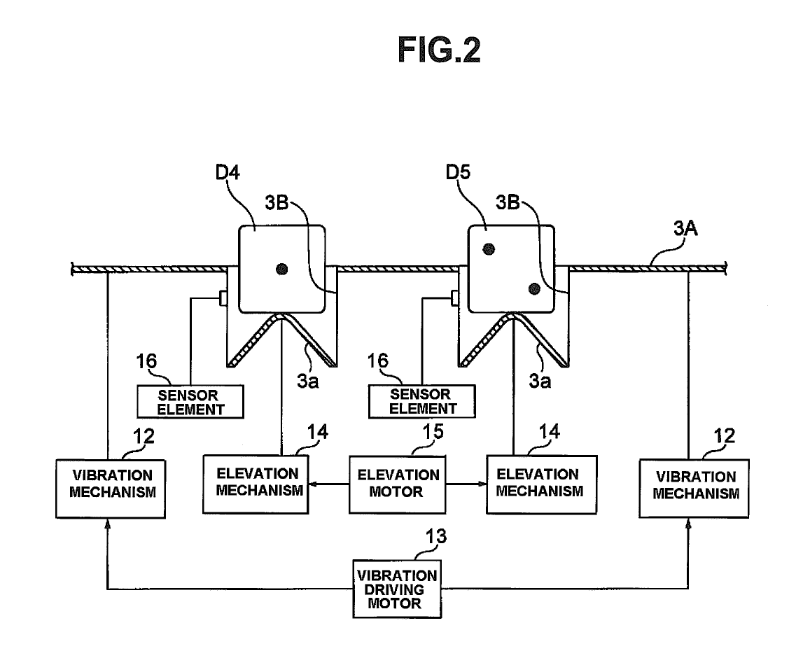

FIG. 2 is a schematic view showing an outline configuration for activating the table 3A mentioned above. A lower face side of the table 3A on which seven dice were placed is supported by means of a vibration mechanism 12 so that the table can be vertically vibrated. The vibration mechanism 12 is provided with an energizing member that permits vertical vibration and a power transmission section or the like for driving this energizing member, so that the table 3A is vertically vibrated by driving a vibration driving motor 13.

The vibration mechanism 12 may be structured to vibrate the table 3A to an extent such that a plurality of dice roll. This mechanism is not a primary characterizing section, and thus, a specific structure thereof is not described.

A pocket 3B formed on the table 3A has a diameter to an extent such that dice can drop with given margins. A bottom part 3a of the pocket is linked with an elevation mechanism 14, and is constituted to be movable in the pocket 3B along the vertical direction. This elevation mechanism 14 is vertically driven by means of an elevation motor 15 to be linked therewith. In addition, the bottom part 3a is formed in a dome shape such that its center protrudes upwardly as a whole. The die that have dropped in the pocket 3B and the die that was positioned on the bottom part 3a, roll in a given direction of the table 3A if the bottom part 3a is upwardly driven by means of the elevation motor 15 and the elevation mechanism 14.

A sensor element 16 is installed at a side wall part of the pocket 3B, making it possible to detect whether or not the die dropped in the pocket 3B.

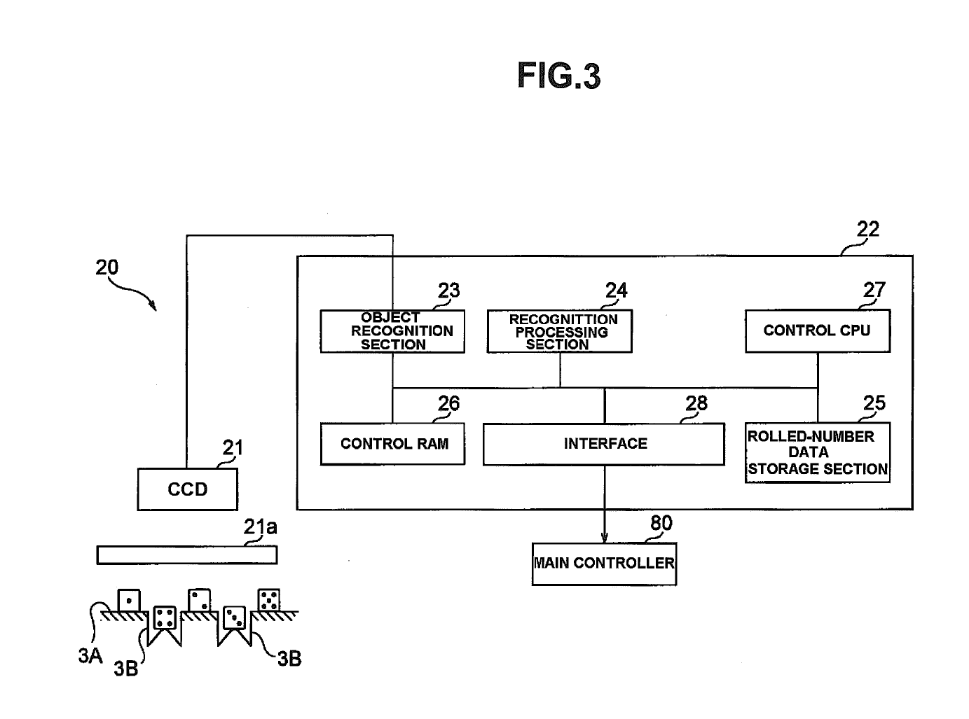

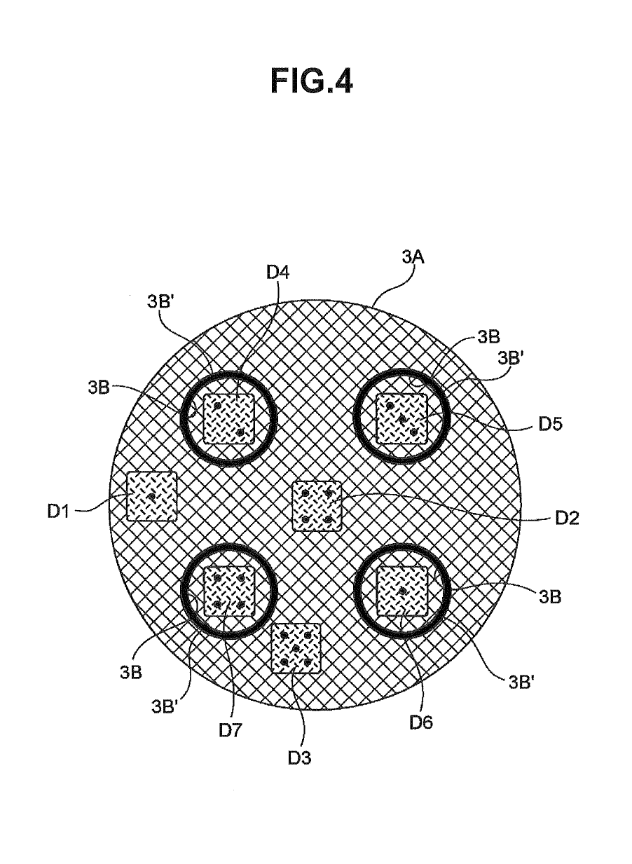

Next, a detection device for detecting rolled numbers of the dice that have been positioned on the table 3A and the dice that have dropped in the pockets 3B will be described with referring to FIGS. 3 and 4. In these figures, FIG. 3 is a block diagram depicting one example of the rolled-number detection device, and FIG. 4 is a view showing an exemplary picked up image of the dice obtained by the rolled-number detection device shown in FIG. 3.

A rolled-number detection device 20 for detecting the stopped rolled number of dice is installed at the top part of a transparent cover 3C that covers the table 3A of the gaming section 3. The rolled-number detection device 20 of the present embodiment, as depicted in the block diagram of FIG. 3, is provided with: an image pickup element (CCD camera) 21 that picks up, as an image, dice that is an object; and a rolled-number detection circuit 22 for detecting rolled numbers by dice.

In the image pickup element 21, focuses are made coincident with each other in advance in the vicinity of the table 3A by means of a lens 2a in order to pick up, as an image, the dice that have been positioned on the table 3A and the dice that have dropped in the pockets 3B. These focuses are controlled to be exposed. The rolled-number detection circuit 22 is provided with: an object recognition section 23 for recognizing a position of an object (dice) upon the receipt of an image pickup signal from the image pickup element; a rolled-number data storage section 25 having stored therein comparison data pertinent to rolled numbers of dice; and a control CPU27 for controlling them. These units are connected via a bus, and each of the units is structured to be controlled by means of the control CPU27.

Specifically, the image pickup signal of the dice formed as an image by means of the image pickup element 21 is measured in intensity distribution at the object recognition section 23. As is schematically depicted in FIG. 4, by measuring the intensity distribution, the positions (surface states) of three dice D1, D2, and D3 that have been positioned on the table 3A can be specified. In addition, by means of a circular boundary part 3B′ formed around the pocket 3B, the dice D4, D5, D6, and D7 that have been positioned inside thereof can be specified discriminately from the dice D1, D2, and D3.

The recognition processing section 24 compares the thus specified seven dice with the rolled-number patterns (six rolled-number patterns) stored in advance in the rolled-number data storage section 25, thereby specifying the rolled-numbers exposed by dice. At this time, the dice that have been positioned inside of the boundary section 3B′ can be discriminated from the outside dice, thus making it possible to discriminately specify the rolled numbers of the three dice existing on the table 3A and those of the four dice that have dropped in the pockets 3B.

The thus specified rolled-number information for a respective one of the seven dice is stored in the control RAM26, and then, the stored information is transmitted to a main controller described later, via an interface 28, at the time of executing payout processing of gaming media. That is, the rolled-number detection device 20 transmits rolled-number information pertinent to the rolled numbers of the seven dice that have dropped at the gaming section 3 (a combination of rolled numbers of the dice existing on the table 3A and a combination of rolled numbers of dice that have dropped in the pockets 3B) to a main controller 80 for controlling the entire dice game machine.

The rolled-number detection device 20 is not limitative to the construction for optically detecting the rolled-numbers, as mentioned above, and can be variously modified as long as the rolled-numbers can be specified, for example, by detecting the rolled-numbers in a magnetic system.

Next, the display screen displayed on the image display device 7 mentioned above while in the play of a game, will be described. In the present embodiment, as described above, three dice finally remain on the table 3A, and four dice drop in four pockets 3B. Thus, BET operation can be performed for two patterns, i.e., a combination of rolled numbers of the three dice that have been positioned on the table (referred to as a first game) and a combination of rolled numbers of the four dice that have dropped in the pockets (referred to as a second game).

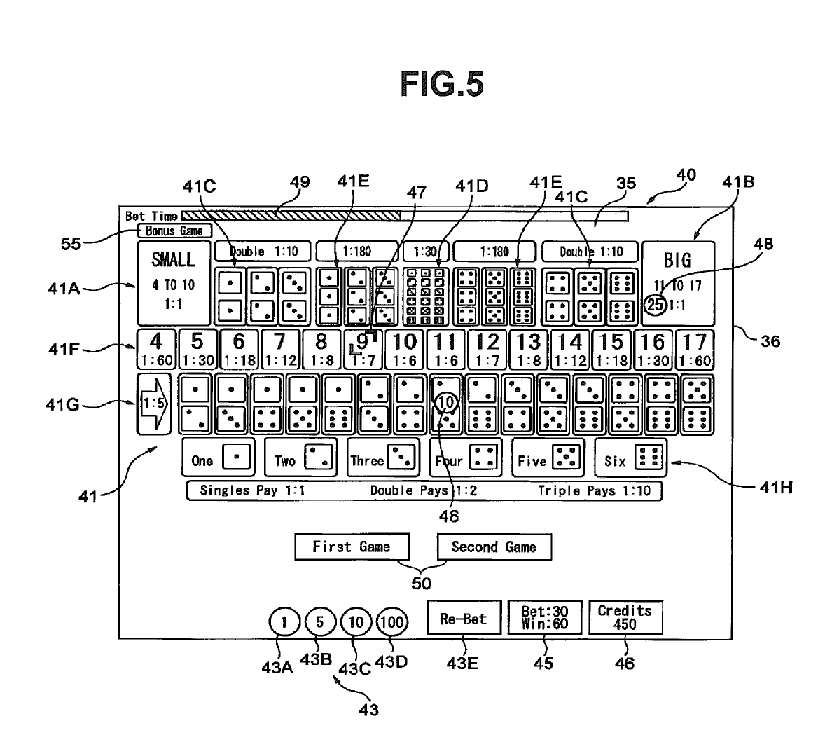

First, a BET table displayed on a liquid crystal screen 36 of an image display device 7 at the time of making BET operation for the first game will be described with referring to FIG. 5. BET operation can be performed using one's own credit while players observe a BET screen 40 displayed on the image display device 7.

On the BET screen 40, a BET area 41 in which dice are displayed is arranged and displayed in a matrix manner. The BET area 41 is specified by depressing (touching) a touch panel 35 with a finger, and a chip is displayed at the specified site, whereby BET operation is made. This BET area 41 is an area in which players make BET operation while predicting the rolled numbers of the three dice implemented at the gaming section 3. The BET area conforms to the rules of SICBO that is generally known.

Downwardly of the BET screen 40, a unit BET button 43, a cashout result display section 45, and a credit amount display section 46 are displayed in sequential order from the left of the screen.

The unit BET buttons 43 are buttons for betting chips on the BET area 41 specified by players. The unit BET buttons are made up of: four types of buttons, i.e., a 1BET button 43A, a 5BET button 43B, 10BET button 43C, and a 100BET button 43D. In the case where BET operation is mistaken, the BET operation can be performed again by touching a Re-BET button 43E.

First, a player specifies a BET portion existing in a BET area 41 to be betted, by directly depressing a screen with a finger or the like. When the 1BET button 43A is depressed in that state, chips can be betted on a one-by-one bet basis (BET number increases in order of “1”->“2”->“3” . . . every time the 1BET button 43A is depressed with a finger or the like). Similarly, when the 5BET button 43B is depressed, chips can be betted on a five-by-five bet basis (BET number increases in order of “5”->“10”->“15”-> . . . every time the 5BET button 43B is depressed with a finger or the like). When the 10BET button 43C is depressed, chips can be betted on a 10-by-10 bet basis (BET number increases in order of “10”->“20”->“30” every time the 10BET button 43C is depressed with a finger or the like). Further, when the 100BET button 43D is depressed, chips can be betted on 100-by-100 bet basis (BET number increases in order of “100”->“200”->“300”-> . . . every time the 100BET button 43D is depressed with a finger or the like). In the BET area 41, the number of chips betted at a current time point is displayed as a chip mark 48. The number displayed on the chip mark 48 indicates the BET number of chips.

The BET number of chips of the players in the previous game and the credit amount of cashout are displayed at the cashout result display section 45. The number obtained by subtracting the BET number from the credit amount of cashout corresponds to the credit amount newly acquired by players by the previous game.

Further, the credit amount owned by the current players is displayed at the credit amount display section 46. This credit amount decreases in response to the BET number (one credit for one chip) when chips are betted. In addition, in a case where the betted chips are won, and then, the cashout of credits is made, the credit amount for the number of cashouts increases. In a case where the credit amount owned by players becomes 0, it is judged that the game is over.

A rod-shaped BET timer graph 49 is provided at an upper part of the BET screen 40. The BET timer graph 49 is a graph for displaying a remaining time during which players can make BET operation. A red graph gradually starts extending to the right side at the time when a game is started. When the red graph has extended to the right-most side, a time during which the players can make BET in a current game expires. At each player terminal 4, when the player's BET time has expired, the table 3A mentioned above is vertically vibrated.

Now, the BET area 41 of the BET screen 40 will be described. The BET area is provided with a plurality of BET portions, and BET operation is made by chipping on the BET portion.

In FIG. 5, BET portions 41A and 41B are portions at which the player makes BET operation while predicting a total value of three dice. That is, if it is predicted that the total number ranges from 4 to 10, the BET 41A is selected, and if it is predicted that the total value ranges from 11 to 17, the BET portion 41B is selected. The payment is set at 1:1 (two payouts for one BET), and in a case where the total value is 3 or 18, (rolled numbers 1, 1, 1 or 6, 6, 6), it is judged to be the player's loss.

The BET portion 41C is a portion at which the player makes BET operation while predicting that the rolled numbers of two dice are identical to each other from among three dice. That is, this portion is where the player makes BET operation while predicting that any of (1, 1) (2, 2) (3, 3) (4, 4) (5, 5) (6, 6) appears from among the three dice, and the payment is set at 1:10.

The BET portion 41D is a portion at which rolled numbers of all of the three dice are identical to each other and the player makes BET operation while predicting that the rolled numbers of the three dice are identical to each other. That is, this portion is where the player makes BET operation while predicting that any of the rolled numbers of the three dice appear as (1, 1, 1) (2, 2, 2) (3, 3, 3) (4, 4, 4) (5, 5, 5) (6, 6, 6), and the payment is set at 1:30.

The BET portion 41E is a portion at which the rolled numbers of all of the three dice are identical to each other, and the player makes BET operation while predicting the numbers. That is, this portion is where the three dice are (1, 1, 1) (2, 2, 2) (3, 3, 3) (4, 4, 4) (5, 5, 5) (6, 6, 6) and the player makes BET operation while predicting the numbers, and the payment is set at 1:180.

The BET portion 41F is a portion at which the player makes BET operation while predicting a total value of three dice. The payment is set in response to the appearance frequency of the total value. In a case where the total value is 4 or 17, the payment is set at 1:60; in a case where it is 5 or 16, the payment is set at 1:30; in a case where it is 6 or 15, the payment is set at 1:18; in a case where it is 7 or 14, the payment is set at 1:12; in the case where it is 8 or 13, the payment is set at 1:8; in a case where it is 9 or 12, the payment is set at 1:7; and in a case where it is 10 or 11, the payment is set at 1:6.

The BET portion 41G is a portion at which the player makes BET operation while predicting the rolled numbers of two of the three dice, and the payment is set at 1:5.

The BET portion 41H is an area in which the player makes BET operation while predicting the rolled numbers of dice, and the payment is set in response to the numbers of the dice coincident with the predicted rolled numbers. For example, in a case where the player makes BET operation while predicting that the rolled number is “1”, the payment is 1:1 when one “1” is included in the rolled numbers of the three dice; the payment is set at 1:10 when two “1”s are included in the rolled numbers of the three dice; and the payment is set at 1:10 when three “1”s are included therein.

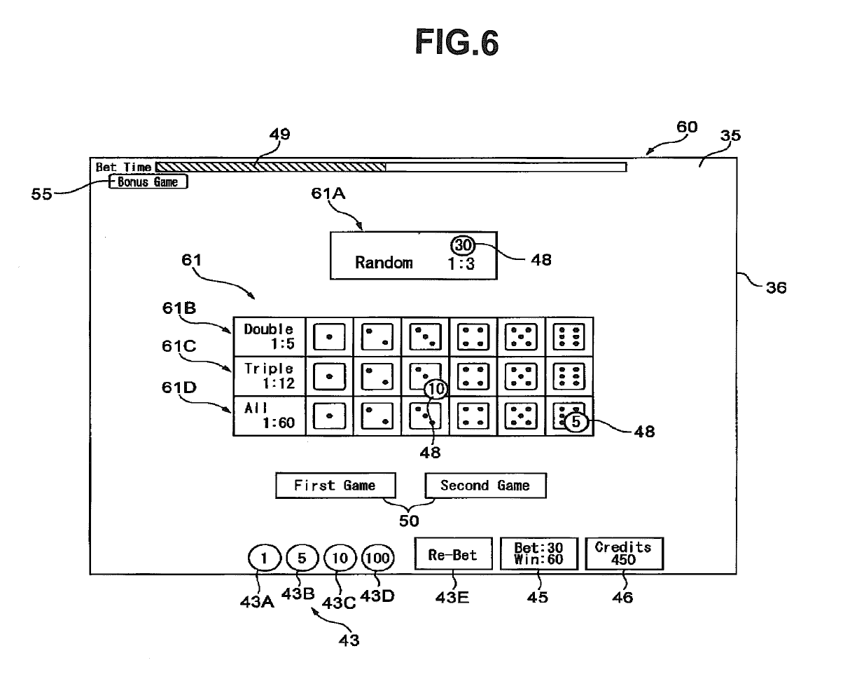

A switching button 50 is installed downwardly of the BET area mentioned above, so that BET operation can be made for a second game in place of the first game mentioned above. That is, when the second game of the switching button is touched, a BET screen 60 shown in FIG. 6 is displayed, enabling BET operation as to the rolled numbers of dice that have dropped in the pockets 3B.

Hereinafter, the BET screen 60 will be described. The same operating section as the BET screen 40 mentioned above is designated by the same reference numeral, and a detailed description thereof is omitted.

A BET area 61 of the BET screen 60 is provided with a plurality of BET portions, and BET operation is made by chipping on the BET portion.

In FIG. 6, the BET portion 61A is a portion at which the player makes BET operation while predicting that, as to four dice that have dropped in the pockets, the same rolled numbers do not appear (i.e., while predicting that the rolled numbers of all of the four dice are different from each other). The payment is set at 1:3 and in a case where the same rolled numbers have appeared, it is judged to be the player's loss. In the figure, it is shown that 30 chips have been betted on the BET portion 61A.

The BET portion 61B is a portion at which the player makes BET operation while predicting that the rolled numbers of two of the four dice are identical to each other. That is, this portion is where the player makes BET operation while predicting that any of (1, 1) (2, 2), (3, 3) (4, 4) (5, 5), (6, 6) appears among the four dice, and the payment is set at 1:5. In a case where the rolled numbers of all of the four dice are different from each other, in a case where the rolled numbers of the three dice are identical to each other, or alternatively, in a case where the rolled numbers of the four dice are identical to each other, it is judged to be the player's loss.

The BET portion 61C is a portion at which the player makes BET operation while predicting the rolled numbers of three of the four dice are identical to each other. That is, this portion is where the player makes BET operation while predicting that any of (1, 1, 1) (2, 2, 2) (3, 3, 3) (4, 4, 4) (5, 5, 5) (6, 6, 6) appear among the four dice, and the payment is set at 1:12. In a case where the rolled numbers of all of the four dice are different from each other, in a case where the rolled numbers of the two dice are identical to each other (including two pairs such as 1, 1 and 2, 2), or alternatively, in a case where the rolled numbers of the four dice are identical to each other, it is judged to be the player's loss. In the figure, it is shown that the player has betted 10 chips while predicting that (3, 3, 3) appears.

The BET portion 61D is a portion at which the player makes BET operation while the rolled numbers of all of the four dice are identical to each other. That is, this portion is where the player makes BET operation while predicting that the rolled numbers of the four dice appear as any of (1, 1, 1, 1) (2, 2, 2, 2) (3, 3, 3, 3) (4, 4, 4, 4) (5, 5, 5, 5) (6, 6, 6, 6), and the payment is set at 1:60. In a case where the rolled numbers of all of the four dice are different from each other, in a case where the rolled numbers of the two dice are identical to each other (including two pairs such as 1, 1 and 2, 2), or alternatively, in a case where the rolled numbers of the three dice are identical to each other, it is judged to be the player's loss. In the figure, it is shown that the player has betted five chips while predicting that (6, 6, 6, 6) appears.

As described above, the player can make BET operation for either or both of the first and second games mentioned above by selecting any of switching buttons 50 in the touch panel of the image display device.

In the dice game machine of the present embodiment, in a case where the rolled numbers of the three dice existing on the table 3A at the gaming section 3 or those of the four dice that have dropped in the pockets 3B conform to a predetermined condition, the player at the player terminal implements a bonus game in which a large amount of gaming media can be acquired.

Further, in addition to implementation of the bonus game mentioned above, the dice game machine of the present embodiment is provided with a so called progressive bonus function (a jack pot) of, every time BET operation is performed at each player terminal 4, storing part thereof (for example, an extent of 1% to 3% of a total BET amount), and, when a predetermined condition is established, paying out the stored gaming media to the player terminal at which the condition is established.

Hereinafter, a bonus game, which is implemented at the dice game machine according to the present embodiment, and a progressive bonus function, will be described.

A condition for establishing a bonus game in the present embodiment (a condition for proceeding to the bonus game) is set in a second game. This condition is set in a case where the rolled numbers of four dice that have dropped in the pocket 3B are identical to each other and the player makes BET operation while predicting such rolled numbers (the player makes BET operation for the BET portion 61D).

As set forth above, when a predetermined condition is established, in the image display device 7, a bonus game display section 55 is lit, the state is notified to players, and the players can implement a bonus game in which a large amount of gaming media can be acquired. Although the specific contents of this bonus game are not limitative to specific ones, for example, the dice game to be implemented at the gaming section 3 proceeds to a bonus game at the player terminal at which the bonus game was established. That is, at the player terminal at which the bonus game was established, in next games (which may be subsequent several games), the players activates all of the BET sections in the BET areas 41 and 61 mentioned above without making BET operation while one chip is betted. In this manner, the players can acquire more gaming media.

The bonus game is not limitative to that to be implemented at the gaming section 3. For example, the dice game may be implemented at the gaming section 3 and a unique bonus game, or alternatively, at intervals of the next dice game, a unique bonus game may be implemented at the image display device 7 of the corresponding player terminal. In this case, the bonus game is implemented as a video game such as a dice game or a card game.

In addition, the progressive bonus is established by winning lottery processing to be implemented at the main controller 80 for controlling operation of a dice game machine described later.

The requirements for the lottery processing mentioned above to be implemented are set in the first and second games. In the first game, the above requirements are set in a case where the rolled numbers of three dice that stopped on the table 3A of the gaming section 3 are identical to each other and the players have made BET operation while predicting such rolled-numbers. In addition, in the second game, the above requirements are set in a case where the rolled numbers of four dice that have dropped in the pocket 3B are identical to each other and the players have made BET operation while predicting such rolled numbers (the players have made BET operation for the BET portion 61D).

That is, in a case where such condition is established, the players can receive a special payment exerted by selecting the BET sections 41E and 61D and can implement the bonus game mentioned above. Further, the players can obtain a progressive bonus exerted by lottery. In this case, the winning probability of the progressive bonus is properly set by means of lottery processing to be implemented at the main controller 80 described later.

The bonus game mentioned above may be implemented together while a progress bonus function is employed. That is, payout processing in the bonus game that is established under a predetermined condition may be performed by the gaming media stored through the BET operation from each player terminal 4. In addition, the progressive bonus function may be a constituent element other than that included in a dice game machine.

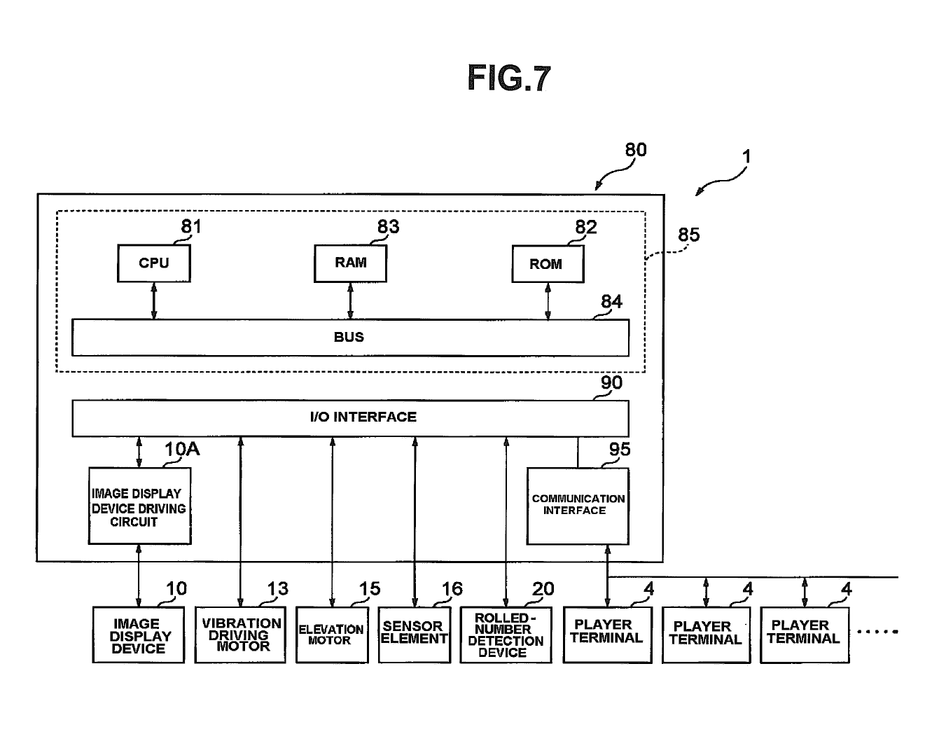

Next, a construction pertinent to a control system of the dice game machine 1 mentioned above, will be described with referring to FIG. 7. FIG. 7 is a block diagram schematically depicting the control system of the dice game machine.

The main controller 80 of the dice game machine 1 has a main control CPU81, a ROM82, a RAM83, and a microcomputer 85 constituted while a bus 84 for transferring data between them is employed as a base.

The CPU81 is connected, via an I/O interface 90, to various devices for driving the gaming section 3. Specifically, this CPU is connected to a vibration driving motor 13 for driving a vibration mechanism 12, an elevation motor 15 for driving an elevation mechanism 14, and a sensor element 16 or the like. The rolled-number detection device 20 mentioned above is connected to the I/O interface 90. Signals pertinent to the rolled number of each of the three dice that have stopped on the table 3A and that of each of the four dice that have dropped in the pocket 3B are transmitted/received to/from the rolled-number detection device 20. In addition, an image display device driving circuit 10A is connected to the I/O interface 90, so that an effect image associated with the gaming operation at the gaming section 3 is displayed at the image display device 10 mentioned above.

The image display device driving circuit 10A is made up of a program ROM, an image control CPU, a work RAM, a VDP (Video Display Processor), and a video RAM or the like. The program ROM stores image control programs pertinent to the display at the image display device 10 and various selection tables, and the image ROM stores dot data for forming the images displayed at the image display device 10, for example. In addition, the image control CPU determines the images to be displayed at the image display device 100 from among the dot data stored in advance in the image ROM, in accordance with the image control programs stored in advance in the program ROM. This determination is based upon the parameters set at the CPU81. Thus, an operation of dice rolling at the gaming section 3 and an operation of predetermined characters as shown in FIG. 1, for example, in accordance with a stop operation, are controlled. The work RAM is constituted as temporarily storing means when the image control CPU executes the image control programs. The VDP forms images corresponding to the display contents determined by the image control CPU, and then, outputs the formed images to the image display device 10. The video RAM is constituted as temporarily storing means when the VDP forms images.

Further, a communication interface 95 is connected to the I/O interface 90. Via this communication interface 95, the main controller 80 transmits/receives various data such as BET information and payment information to/from each player terminal 4.

A ROM82 in the main controller 80 is made up of a semiconductor memory or the like, for example. This ROM stores: programs for controlling various drive units for driving the gaming section 3; programs for implementing the progressive function mentioned above; and programs or the like for primarily controlling each player terminal 4; and stores a payment table or the like to be referenced in executing a dice game.

The RAM83 is a memory for temporarily storing various data computed by the CPU81. For example, this RAM temporarily stores: BET information of chips transmitted from each player terminal 4; BET accumulation information indicative of the fact that the BET amount of chips transmitted from each player terminal 4 is accumulated at a predetermined rate; the rolled-number information of the dice existing on the table 3A transmitted from the rolled-number detection device 20, which is a gaming result at the gaming section 3, and the dice that have dropped in the pockets 3B; and data or the like pertinent to a result of processing executed by the CPU81.

Then, the CPU81 controls: a vibration drive motor for driving the gaming section 3; an elevation motor 15; an image display device 10; and a rolled-number detection device 20, based upon the data and programs stored in the ROM82 and the RAM83. This CPU executes control processing associated with the progress of a game, such as rolling of the dice at the gaming section 3 and stoppage thereof; control of display images at the image display device 10; and detection of rolled numbers.

In addition to the control processing associated with the progress of a game, the CPU81 has a function of transmitting/receiving data to/from each player terminal 4, and then, primarily controlling each player terminal 4 to conduct a game. Specifically, this CPU accepts the BET information transmitted from each player terminal 4; performs winning determination processing of chips betted, based upon the BET information transmitted from each player terminal 4; and then, calculates the credit amount to be paid out at each player terminal 4 with referring to a payment table.

In addition, the CPU81 determines whether or not a bonus game is established at the time of performing the winning determination processing mentioned above; drives and controls various drive members of the player terminal in order to implement a bonus game; and calculates the credit amount to be paid out at the player terminal at which the bonus game was implemented, with referring to the payment table.

Further, the CPU81 executes lottery processing of the progressive bonus mentioned above. This lottery processing is implemented at any player terminal, in a case where the conditions as set forth above were established. In other words, the lottery processing is implemented in a case where: in the first game, the rolled numbers of three dice that stopped on the table 3A of the gaming section 3A are identical to each other and the players have made BET operation while predicting such rolled numbers (the players have made BET operation for the BET portion 41E); and in the second game, the rolled numbers of the four dice that have dropped in the pocket 3B are identical to each other and the players have made BET operation while predicting such rolled numbers (the players have made BET operation for the BET portion 61D).

Lottery processing is not limitative to a specific approach. For example, this processing can be executed by sampling any random numbers while a random number generator and a sampling circuit or the like are connected to the CPU81, for example. Further, the above lottery processing can be executed by sampling random numbers on the operating programs of the CPU81. Alternatively, the players are caused to implement a special game separately, and then, according to the result of the game, a winning prize may be awarded to the players.

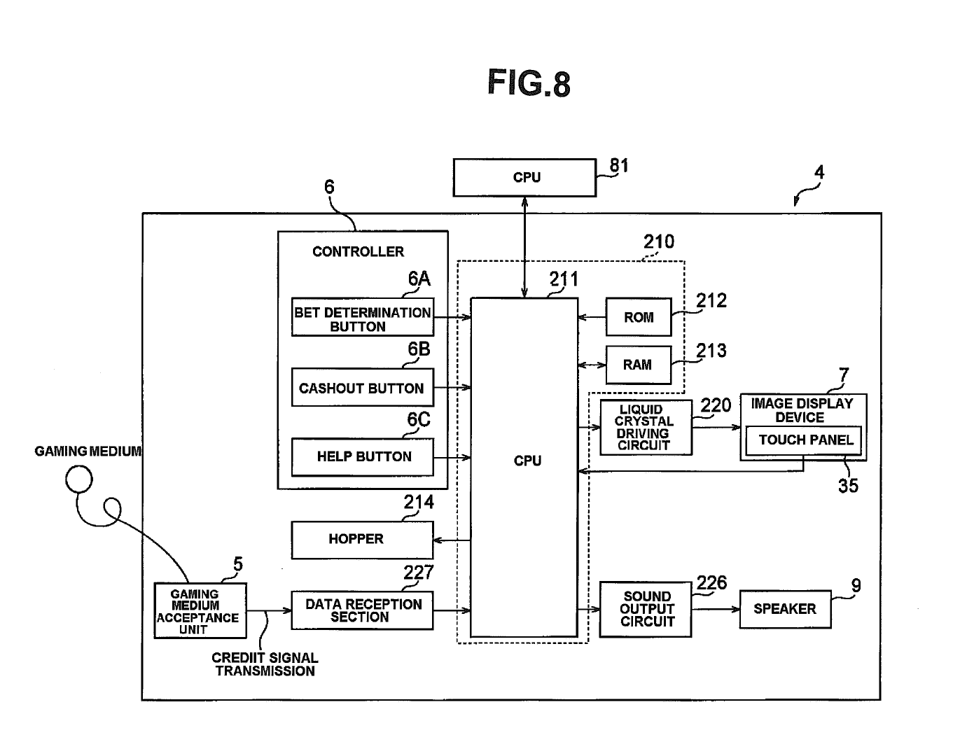

Next, a configuration pertinent to a control system of the player terminal 4 connected to the CPU81 of the main controller 80 mentioned above, will be described. FIG. 8 is a block diagram schematically depicting the control system of the player terminal 4 according to the present embodiment.

The player terminal 4 is provided with: a player terminal controller 210 for controlling an operation of the player terminal 4; and the peripheral devices mentioned above.

The player terminal controller 210 is provided with: a CPU211 for controlling the player terminals; a ROM212; and a RAM213.

The ROM212 is made up of a semiconductor memory or the like, for example. The ROM212 stores: programs for implementing basic functions of the player terminals 4; various programs required for controlling the player terminals 4; and a data table or the like.

The RAM213 is a memory for temporarily storing: various data computed by the CPU211; the credit amount currently owned by the players; and a BET situation or the like of chips betted by the players.

In addition, a BET determination button 6A, a CASHOUT button 6B, and a HELP button 6C, which are provided at a controller 6 (see FIG. 1), are connected to the CPU211, respectively. Then, the CPU211 performs control to execute a variety of corresponding operations, based upon an operation signal to be outputted by an operation such as pressing each of the buttons. Specifically, upon the receipt of the fact that the player's operation has been inputted, this CPU executes various processing operations, based upon the input signals supplied from the controller 6 and the data and programs stored in the ROM212 and the RAM213, and then, transmits the result to the CPU81 of the main controller 80 mentioned above.

In addition, a hopper 214 is connected to the CPU211, and the hopper 214 pays out a predetermined number of gaming media from payout openings 8, by means of a command signal from the CPU211.

Further, the image display device 7 is connected to the CPU211 via a liquid crystal driving circuit 220. The liquid crystal driving circuit 220 is made up of: a program ROM; an image ROM; an image control CPU; a work RAM; a VDP (Video Display Processor); and a video RAM or the like. The program ROM stores: image control programs pertinent to the display at the image display device 7; and various selection tables. The image ROM stores dot data for forming the images displayed on the image display device 7, for example. In addition, the image control CPU determines the images displayed on the image display device 7 from among the dot data stored in advance in the image ROM, in accordance with the image control programs stored in advance in the program ROM. This determination is based upon the parameters set at the CPU211. In addition, the work RAM is constituted as temporarily storing means when the image control CPU executes the image control programs. In addition, the VDP forms images corresponding to the display contents determined by the image control CPU, and then, outputs the formed images to the image display device 7. The video RAM is constituted as temporarily storing means when the image control CPU executes the image control programs. In addition, the VDP forms the images corresponding to the display contents determined by the image control CPU, and then, outputs the formed images to the image display device 7. The video RAM is constituted as temporarily storing means employed when the VDP forms images.

On the front of the image display device 7, a touch panel 35 is mounted as set forth above, and operational information of the touch panel 35 is transmitted to the CPU211. The touch panel 35 senses BET operation of the player's chips on the BET screens 40 and 60 mentioned above (see FIGS. 5 and 6). Specifically, selections of the BET area 41 of the BET screen 40 and the BET area 61 of the BET screen 60 and operation or the like of a unit bet button 43 are performed by touching the touch panel 35, and the information is transmitted to the CPU211. Then, based upon the information, the current player's BET information (the BET areas 41 and 61 specified on the BET screens 40 and 60 and the number of betted chips) is stored whenever necessary. Further, the BET information is transmitted to the CPU81 of the main controller 80, and the transmitted information is stored in the BET information storage area of the RAM83.

Further, a sound output circuit 226 and a speaker 9 are connected to the CPU211, and the speaker 9 generates various effect sounds when various attractive effects are provided, based upon an output signal from the sound output circuit 226. In addition, a gaming medium accepting unit 5 serving as a unit for entering a gaming medium such as a bill or a medal is connected to the CPU211 via a data reception section 227. The data reception section 227 receives a credit signal transmitted from the gaming medium accepting unit 5, and the CPU211 increases the player's credit amount stored in the RAM213, based upon the transmitted credit signal.

Next, control operation of the dice game machine 1 constituted as set forth above and the behavior of dice will be described in accordance with operation to be performed when the player plays a game at the player terminal 4.

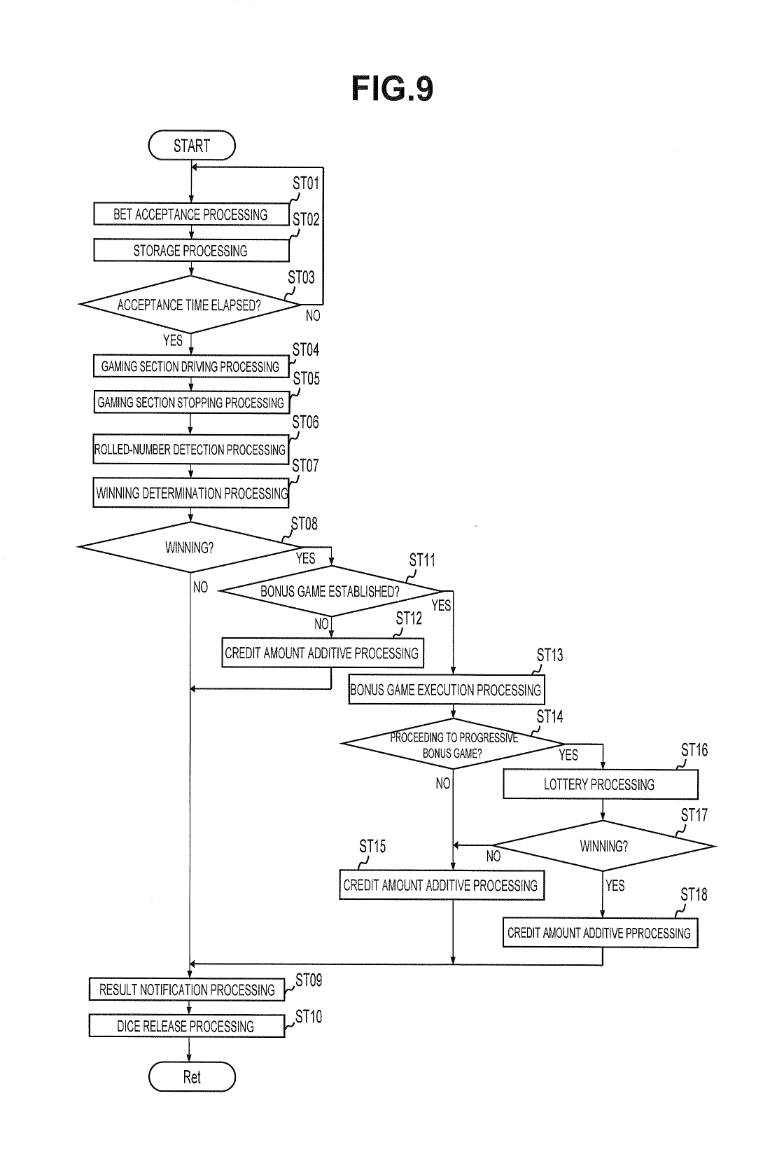

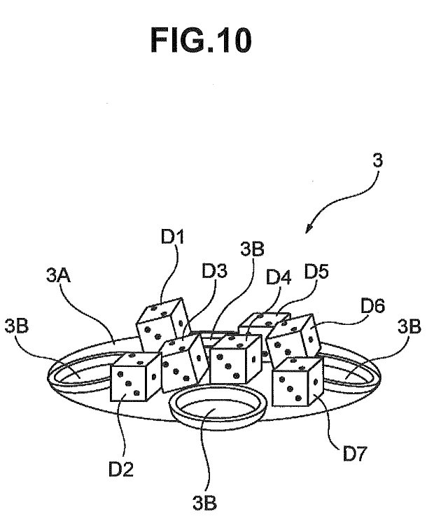

FIG. 9 is a flowchart showing control operation of procedures for executing a dice game between the main controller 80 of the dice game machine 1 and the player terminal 4. FIGS. 10 to 12 are views showing the behavior of dice in the play of one game.

First, the dice game machine 1 performs BET acceptance processing (step: ST01). During this BET acceptance processing, the player sitting at the player terminal 4 inserts a game medium such as a coin or a medal into the gaming medium accepting unit 5, and then, performs the BET operation mentioned above while observing the BET screen 40 (see FIG. 5) and the BET screen 60 (see FIG. 6) of the image display device 7 in response to the insertion. During BET acceptance processing, a BET timer graph 49 is displayed on the BET screens 40 and 60 at each player terminal, and the main controller 80 accepts BET operation within this period of time. The BET-enable number (remaining chip amount) is displayed in a subtractive manner every BET operation at a credit amount display section 46 of each of the BET screens 40 and 60.

At this time, the gaming section 3 waits for the commencement of a game in a state in which seven dice are placed on the table 3A, as shown in FIG. 10.

Upon acceptance of the above-mentioned BET operation from each player terminal, the main controller 80 writes the BET contents in a predetermined storage area of the RAM83 and stores part of the BET (for example, in order of 1% to 3%) (ST02). The stored BET amounts (amounts of gaming media) are sequentially written in the predetermined storage area of the RAM83.

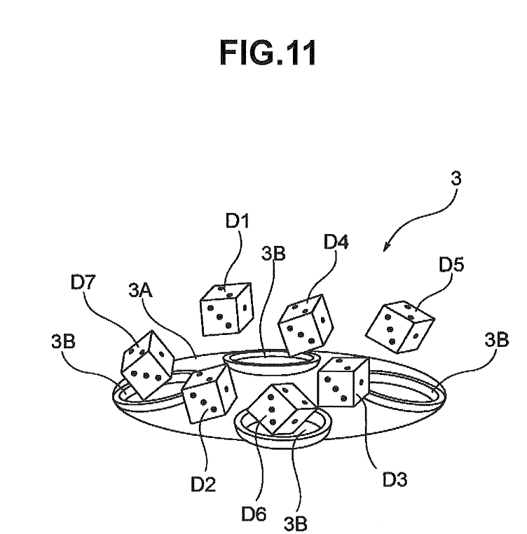

The above-mentioned operation is executed until the BET acceptance time has elapsed (ST03). When the BET acceptance time has expired, the CPU81 of the main controller 80 drives a vibration driving motor in order to drive the gaming section 3, and then, vertically vibrates the table 3A (ST04). At this time, at the gaming section 3, seven dice roll, as shown in FIG. 11, and the rolling dice gradually drop in the pockets 3B.

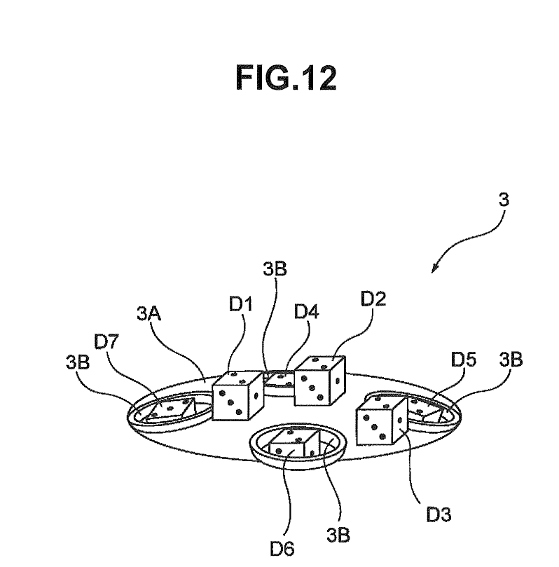

As set forth above, a sensor element 16 is installed in each pocket 3B, and then, the main controller 80 stops the gaming section 3 upon the receipt of a signal indicative of the fact that the dice dropped in the pockets, from all of the sensor elements (ST05). At this time, as shown in FIG. 12, three dice exist on the table 3A, and one die drops in each of the four pockets 3B (ST06). During the rolled-number detection processing at the gaming section 3, the rolled-number detection device 20 mentioned above is driven, and then, rolled-number information of the dice exposed on a surface is detected. At this time, a combination of rolled numbers of the dice on the table 3A and a combination of the dice that have dropped in the pockets 3B are individually recognized, and then, the rolled-number information of the dice is transmitted to the main controller 80. Then, the CPU81 executes winning determination processing among the BET information for each player terminal, which is stored in the RAM83 (ST07).

At this time, if it is not determined to be winning (ST08, NO), it is judged to be the player's loss, and the result is transmitted to the player terminal (ST09). At each player terminal, result display processing such as displaying “LOSS” is performed at a payout result display section 45 of each of the BET screens 40 and 60. Then, in a case where a bonus game is not established at all of the player terminals, the CPU81 of the main controller 80 drives the elevation motor 15 in order to proceed to a next game; the dice having dropped in the pockets 3B are released onto the table 3A; and one game terminates.

As set forth above, a bottom part 3a of the pocket 3B is formed in a dome shape. Thus, when the dice are released, the dice release direction is arbitrarily determined, and, as shown in FIG. 10 again, 7 dice are randomly placed on the table 3A.

In the winning determination processing at ST08 mentioned above, if it is determined to be winning, it is continuously determined whether or not a bonus game is established (ST08, YES, ST11). A condition for establishing the bonus game, as described above, is set in a case where, in the second game, the rolled numbers of the four dice that have dropped in the pockets 3B are identical to each other and the players have made BET operation while predicting such rolled numbers (the players have made BET operation for the BET portion 61D).

If the bonus game is not won (ST11, NO), calculation of a payment amount (credit amount additive processing: ST12) is executed with referring to a predetermined payment table as it is; the result is stored in a predetermined work area of the RAM83; and then, a winning determination signal is transmitted to each player terminal 4 (ST09). The CPU211 of each player terminal 4 drives and controls the liquid crystal driving circuit 220, based upon the winning determination signal transmitted from the main controller 80. This CPU also updates the payout result display section 45 and the credit amount display section 46 displayed on the BET screens 40 and 60. In addition, the CPU211 of each player terminal 4 drives the liquid crystal driving circuit 220 and the sound output circuit 226, and then, provides an image effect or a sound effect, whenever necessary.

On the other hand, if the bonus game is won (ST11, YES) bonus game execution processing is performed as it is (ST12), and then, it is determined whether or not the routine proceeds to a progressive bonus (ST14). A condition for proceeding to a progressive bonus, as described above, is that: a bonus game is established; further, in a first game, rolled numbers of three dice that stop on the table 3A of the gaming section 3 are identical to each other; and the player has made BET operation while predicting such rolled numbers (i.e., the player has made BET operation for the BET portion 41E)

In the bonus game processing mentioned above, the fact that the bonus game has been established is notified to the corresponding player terminal 4. At the player terminal, upon the receipt of this establishment signal, the CPU211 of the player terminal 4 validates the BET areas 41 and 61 on the BET screens 40 and 60 as to a next dice game at the gaming section 3. That is, this validation processing denotes that single chips have been betted in all regions of the BET areas 41 and 61 on the BET screens 40 and 60. Therefore, the player is given a chance that a large amount of gaming media can be obtained in the next dice game.

At ST14 mentioned above, if the routine does not proceed to a progressive bonus (ST14, NO), calculation of a payment amount (credit amount additive processing; ST15) is executed with referring to a predetermined payment table as it is. The calculation of the payment amount is associated with: a payment acquired based upon the result of a game at the gaming section 3 prior to proceeding to the bonus game; and a payment acquired based upon the result of the bonus game mentioned above. After the calculation result of the summed payment amount is stored in a predetermined work area of the RAM83, a winning determination signal is transmitted to the player terminal 4 (ST09). The player at the player terminal performs update processing or the like of the payout result display section 45 and the credit amount display section 46 displayed on the BET screens 40 and 60, in the same manner as that described above. That is, the player can obtain a regular payment at the gaming section 3 and a payment of the bonus game at one time.

In the processing of ST14 mentioned above, in a case where a condition for a progressive bonus is established, the CPU81 of the main controller 80 performs lottery processing of the progressive bonus in parallel with the bonus game (ST16). This lottery processing is executed by sampling any random numbers in the CPU81, as described above. Then, predetermined random number values are sampled, whereby winning of the progressive bonus (a jack pot) is realized.

If the progressive bonus is not won (ST17, NO), calculation of a payment amount and processing of transmitting a payment result to the player terminal are executed in accordance with the processing operations of STl5 and ST09 mentioned above.

On the other hand, if the progressive bonus is won based upon the lottery result (ST17, YES), credit amount additive processing (ST18) is executed. The calculation of the payment amount is associated with: a payment acquired based upon the result of the game at the gaming section 3 prior to proceeding to the bonus game mentioned above; and a payment exerted by winning on the progressive bonus game (specifically, the past BET amount stored at the time of implementing a dice game; and storage amount written in the RAM83 at ST02). After the calculation result of the summed payment amount is stored in a predetermined work area of the RAM83, the stored result is transmitted to the player terminal 4 (ST09).

At this time, the player at the player terminal performs result display processing such as displaying the BET amount and the amount of acquired gaming media at the payout result display section 45 of each of the BET screens 40 and 60. That is, the players can obtain a regular payment at the gaming section 3, a bonus payment, and a payment exerted by winning on a progressive bonus at one time. Of course, at this time, the image display devices 7 and 10 or the like may provide a special effect separately.

Concurrently, the CPU81 of the main controller 80 drives the elevation motor 15 in order to proceed to a next game and release the dice on the table 3A in a random state (ST10, see FIG. 10), and then, one game terminates.

According to the dice game machine 1 constituted as set forth above, in addition to prediction of three dice to be performed on the table 3A of the gaming section 3, the player can predict the rolled numbers of the dice that drop in the pockets 3B provided on the table, thus making it possible to increase the number of objects to be betted, enhance excitement, and enhance enjoyment. In particular, in the dice game machine constructed as set forth above, after a game is started, a plurality of dice roll on the table 3A and drop in the pockets 3B, so that the player pay attention to the behavior of the dice, making it possible to enhance expectation and excitement. Eventually, the players may make BET operation for either of a combination of the rolled numbers of the dice on the table 3A and those of the dice that have dropped in the pockets 3B.

The image display device 10 installed at the rear of the gaming section 3 displays an effect image of a character together with rolling of a plurality of dice, for example. The display of the effect image augments an atmosphere until the result of the dice game is obtained, making it possible to enhance enjoyment.

The gaming section 3 constituted as set forth above is such that the table 3A vibrates vertically. This constitution enables BET operation while predicting the behavior of dice to some extent, making it possible for the players to have an amusing interest in predictability relative to the result. That is, as shown in FIG. 10, it becomes possible to predict which of the dice drop in pockets and to what extent such that the other dice roll and stop from the positions of a plurality of dice on the table 3A, a distance from the pockets 3B, and the first exposed rolled number. Finally, it also becomes possible to enhance an interest for prediction.

Further, in the above-mentioned configuration, in a case where either of the rolled numbers of the dice which have been positioned on the table 3A and those of the dice which have dropped in the pockets, are obtained in a predetermined combination and the players have made BET operation for the predetermined combination, a bonus game in which an additional gaming value can be obtained is executed for the players. Thus, the players are caused to have an interest in such bonus game, making it possible to enhance enjoyment more. In particular, in the above-mentioned configuration, because a progressive bonus function is provided, a payout amount at a moment at which a jackpot is obtained becomes large, and the players perform games with more interest. In addition, the rolled numbers of the dice for which such payout is made are set a low probability, whereby the payout amount increases more significantly, making it possible to enhance the player's excitement and anticipation.

While the embodiments of the dice game machine and the dice game method, of the present invention, were described, the present invention can be variously modified without being limitative thereto.

For example, at the gaming section 3, it is possible to appropriately modify a specific method for rolling and stopping dice (table vibration method) and a means or the like for determining the number of dice to be employed, the number of pockets, and the rolled numbers of dice. For example, a plurality of dice may be constituted so that they roll on the table 3A and drop in the pockets 3B, and thereafter, the dropped dice are re-collected by a re-collection mechanism, instead of being established in an exposed state. In addition, at the gaming section 3, an image indicative of the fact that dice are rolled and stopped may be displayed using the image display device 10 mentioned above instead of actually rolling the dice.

The number of dice used at the gaming section 3 is not limitative to that indicated in the above-described embodiments, and can be variously modified. According to such modification, it is possible to appropriately modify the betting method and type. In addition, the dice to be used is not limitative to a hexahedron, and may be a polyhedron having more exposed faces. In this case, a face serving as a trigger for proceeding to a bonus game may be formed as one face of such polyhedron. The payment at the BET portion mentioned above is merely provided as one example, and can be appropriately modified on a region-by-region basis or in conformance with regulations or the like.

Further, the condition for establishing the bonus game (the condition for establishing a progressive bonus) and the contents of games can be realized by various methods. For example, the bonus game may be implemented by the image display device 10 instead of the use of the gaming section 3. The contents of the bonus game can be realized in various aspects such as a card game, a roulette game, a slot machine-like game, and a dice game.

What is claimed is:

1. A dice game machine, comprising:
(a) a table on which a plurality of dice roll, the table having pockets in which at least one of the plurality of dice drops;
(b) a vibration section for vibrating the table to roll the dice on the table;
(c) a BET operating section, which enables a player to perform BET operation while predicting at least either of rolled numbers of the dice existing on the table after vibration of the table stops and rolled numbers of the dice that have dropped in the pockets;
(d) a rolled-number recognition section for recognizing rolled numbers of the plurality of dice that are in a stopped state after vibration of the table stops; and
(e) a controller for controlling vibration of the table and a timing at which the vibration of the table stops; accepting BET operation from the BET operating section; and controlling payout processing of a gaming value corresponding to a payment, with referring to rolled numbers of dice specified by the rolled-number recognition section.

2. The dice game machine according to claim 1, comprising:
a plurality of player terminals provided with at least the BET operating section; and
an image display device that can be visually recognized from a player of each of said player terminals,
wherein the controller causes the image display device to display an effect image when the dice on the table vibrates.

3. The dice game machine according to claim 1, wherein:
the rolled-number recognition section recognizes rolled numbers of the dice existing on the table after vibration has stopped and rolled numbers of the dice that have dropped in pockets.

4. The dice game machine according to claim 1, wherein:
the controller executes game processing capable of acquiring an additional gaming value to the player in a case where either of the rolled numbers of the dice on the table and the rolled numbers of the dice that have dropped in pockets are obtained in a predetermined combination and the player has made BET operation for the predetermined combination.

5. The dice game machine according to claim 1, wherein:
the controller executes accumulation processing at a predetermined rate among a BET amount determined when the player makes BET operation; and executes, for the player, payout processing of a past accumulation amount, in a case where either of rolled numbers of the dice existing on the table and rolled numbers of the dice that have dropped in pockets are obtained in a predetermined combination and the player has made BET operation for the predetermined combination.

6. A dice game machine, comprising:
(a) a table on which a plurality of dice roll, the table having pockets in which at least one of the plurality of dice drops;
(b) a vibration section for vibrating the table to roll the dice on the table;
(c) a BET operating section, which enables a player to perform BET operation while predicting at least either of rolled numbers of the dice existing on the table after vibration of the table has stopped and rolled numbers of the dice that have dropped in the pockets;
(d) a rolled-number recognition section for recognizing rolled numbers of the plurality of dice; and
(e) a controller,
the controller being configured to:
(i) accept a process of BET operation from the player via the BET operating section;
(ii) control vibration of the table by means of the vibration section so that a plurality of dice rolls on the table;
(iii) control vibration of the table, which is exerted by the vibration section, to be stopped in a case where it is detected that at least one die has dropped in a pocket of the table;
(iv) control the rolled-number recognition section to recognize predetermined rolled numbers of dice after stopping vibration of the table; and
(v) determine whether or not a combination of the recognized predetermined rolled numbers of the dice conforms to a predetermined condition and pay out a gaming value corresponding to a payment to the player in a case where the accepted BET operation is performed for the predetermined condition.

7. The dice game machine according to claim 6, wherein:
the controller executes a first game in a case the rolled-number recognition section recognizes that a combination of rolled numbers of the dice that have stopped on the table conforms to a predetermined condition, and executes a second game in a case where a combination of rolled numbers of dice that have dropped in pockets of the table conforms to a predetermined condition.

8. A dice game method, comprising the steps of:
(a) vibrating a table on which a plurality of dice roll, the table having pockets in which at least one of the plurality of dice drops;
(b) accepting processing for a player to make BET operation while predicting at least either of rolled numbers of the dice existing on the table after vibration of the table stops and rolled numbers of the dice that have dropped in the pockets;
(c) recognizing rolled numbers of a plurality of specific dice after stopping vibration of the table;
(d) judging whether or not rolled numbers of the plurality of specified dice conform to a predetermined condition; and
(e) paying out a gaming value corresponding to a payment to a player in a case where it is determined that rolled numbers of the plurality of specified dice conform to a predetermined condition and the accepted BET operation is performed for the predetermined condition.

9. The dice game method according to claim 8, further comprising the step of executing, for the player, special game processing capable of acquiring an additional gaming value, in a case where either of rolled numbers of the dice existing on the table and rolled numbers of the dice that have dropped in pockets are obtained in a predetermined combination and the player has made BET operation for the predetermined combination.

10. The dice game method according to claim 8, further comprising the steps of:
executing accumulation processing at a predetermined rate among a BET amount when the player makes BET operation; and
executing, for the player, payout processing of a past accumulation amount, in a case where either of rolled numbers of the dice on the table and the dice that have dropped in pockets are obtained in a predetermined combination and the player has made BET operation for the predetermined combination.
